(19) United States
(12) Patent Application Publication
(10) Pub. No.: US 2018/0096432 A1
(43) Pub. Date: Apr. 5, 2018

(54) METHODS AND SYSTEMS FOR REPRESENTING RELATIONAL INFORMATION IN 3D SPACE

(71) Applicant: RECONSTRUCTOR HOLDINGS LLC, Greenwich, CT (US)

(72) Inventors: Samir Varma, Cos Cob, CT (US); Michael Wayne Shore, Dallas, TX (US)

(21) Appl. No.: 15/833,986

(22) Filed: Dec. 6, 2017

Related U.S. Application Data
(63) Continuation-in-part of application No. 15/097,855, filed on Apr. 13, 2016, now abandoned.
Application No. 15/097,855 is a continuation of application No. 13/942,145, filed on Jul. 15, 2013, now abandoned.
Application No. 13/942,145 is a division of application No. 13/288,660, filed on Nov. 3, 2011, now Pat. No. 8,606,672.
(60) Provisional application No. 61/410,237, filed on Nov. 4, 2010.

(51) Int. Cl. G06Q 40/06

(52) U.S. Cl. CPC G06Q 40/06

(57) ABSTRACT

Systems and techniques are described herein for graphically representing a number of data objects in three dimensional space. In one example, multiple data objects may be graphically represented and manipulated in a three or more dimensional space, with each axis of a three dimensional grid representing one or more variables or variables of the data objects. A graphical user interface may be provided that enables configuration of the display (visual, or alpha numeric, or both) of any number of variables associated with the data objects of interest. The graphical user interface may also provide for controls that enable manipulation of the data objects themselves and their representation in the three dimensional space. In some aspects, the graphical user interface may provide for animations of the data objects, representing changes in values of the variables associated with the data objects over time to more efficiently convey trend information.

### CROSS REFERENCE TO RELATED APPLICATIONS

This application is a continuation-in-part application of U.S. patent application Ser. No. 15/097,855 filed Apr. 13, 2016, which is a continuation application of U.S. patent application Ser. No. 13/942,145 filed Jul. 15, 2013, which is a divisional of U.S. patent application Ser. No. 13/288,660, filed Nov. 3, 2011, now U.S. Pat. No. 8,606,672, which is based upon and claims the benefit of priority from the U.S. Provisional Application No. 61/410,237, filed on Nov. 4, 2010; the entire contents of all the above-listed priority documents of which are incorporated herein by reference.

### FIELD

The embodiments discussed herein relate to a method and system for analyzing and displaying information graphically. More specifically, a method and system that provides comparisons, via a three or more dimensional plot or virtual reality environment, of information, such as investment or sports information, based on an analysis of the information is described.

### BACKGROUND

Financial markets, such as the stock market, provide a vehicle for consumers to make financial investments with the hope of monetary gain. For example, stocks of a corporation purchased by a consumer can provide monetary gains for the consumer if the stock value increases over time. Before making an investment in the stock market, a consumer should undertake a considerable amount of time to research the investment. However, consumers are easily overwhelmed by the amount of factors that can be taken into account when attempting to make a smart investment decision and may only wish to focus on customized factors that are most relevant to a consumer's portfolio needs. Further, it is difficult for consumers to determine the risk and reward levels of various investments as well as the similarity and/or differences between various investments based on these factors.

Financial markets can also be extremely volatile which can result in sudden losses with respect to a consumer's investment. This sudden loss can cause the consumer to dispose of the investment regardless of potential future gains. For example, a consumer may notice a sudden drop in a stock price and proceed to sell the stock to avoid further losses. However, the stock price over a longer period of time may show a significant increase thereby resulting in a missed opportunity by the consumer for long-term monetary gain.

A need exists for a method and system for analyzing investment information that allows a consumer to generate customized investment analysis and advice based on a variety of factors identified by the consumer. Further, a need exists for providing risk and reward information as well as comparison information between investments based on the above-noted factors in a way that intelligently informs a consumer of investment value in the past, present and into the future. In addition, a need exists for more useful sports information analysis and a way to access and represent that analysis.

### SUMMARY

In order to solve at least the above-noted problems, the present advancement relates to information processing apparatus and associated method for analyzing investment information relating to a financial indicator. An input unit receives a financial request and one or more investment variables relating to the financial indicator and a description vector unit generates at least two vectors containing the one or more investment variables based on the financial request. A description vector similarity unit then calculates a similarity value by comparing the at least two vectors and an investment analysis unit analyzes the similarity value and the financial request, and determines investment advice based on results of the analysis.

In some aspects, the data and analysis associated with the data may be graphically represented via a fully customizable and configurable graphical user interface. In some implementations, the data may include financial data. In other implementations, the data may include other types of data, such as sport related information (player stats, fantasy league, etc.). The user interface may represent the data in three dimensional (3D) space, for example via a display device or virtual reality or augmented reality device or devices. Each axis of the 3D space defines or represents one or more variables of interest. In some cases, more than one variable may be represented by a single axis, such that values of the two or more variables may be combined. In one example, an ideal value (e.g., for comparison, as a goal, etc.) for a number of selected variables may be obtained. These values may be graphed or plotted onto a 3D plane, such as a 3D grid or space. Values of interest, such as investment assets or opportunities, may be obtained, such as for example, from one or more databases, or via other means. These values may also be graphed or plotted in the 3D space. The values may then be compared to the ideal value, and a vector representing the difference may be generated. The vector may define the distance of the values to the ideal value, both in the 3D space and in the parent N-dimensional space. The data, and more specifically the relative value of multiple variables may be more readily graphically represented and visually understood, via the relative distances between points in the 3D space. Information, such as relating to financial investments, sports teams performance, and other data may find particular applicability with the described systems and methods.

In some aspects, four dimensions may be represented and visualized in the three dimensional space, via changing of the values of interest (and in some cases, also the ideal value) in the space, e.g., via movement within the three dimensional space. The fourth dimension may represent time, or any other variable or combination of variables. In some aspects, the three or more dimensional display may be displayed, controlled, and/or manipulated using virtual reality or augmented reality. Controls may be provided that navigate through the 3D space, for example based on gestures.

In some examples, more dimensions may be represented via other visual indicators, such as different colors, shapes, textures, line dashing, flashings, and so on. In some cases, selecting or hovering over a data point (representing a value of interest), for example that represents a potential investment, may display additional information of the investment. In some examples, selection or touching of a data point may reveal more information, expand its view, contract its view, turn it on its axis to reveal other information about the data point, change its color, size, brightness, contrast and other characteristics to reveal information about the data point. In some cases, each data point may have or be associated with different touch points that do different things—for example touch a stock's representation from the left and it does/shows one piece of information or metric, but touch it from the top and it does or shows another piece of information, metric, etc.

In some aspects, the user interface may provide controls to expand the field of view to see more detail about a data point or group of data points, such as a stock or group of stocks, based on user movements, such as moving hands or arms apart in some given volume of space (breaststroke outwards). The user interface may also provide controls to contract the field of view to see more data points or stocks in less detail based on user movements, for example by movement of arms or hands in a reverse breaststroke.

In some examples, 3D or virtual reality controls may include projecting “touch pads” or other control objects on the walls/ceilings/floor or even in the volume of a room that allow a user to manipulate the data and the perspective of the 3D space. By using an entire room (e.g., and office, conference room, or other physical room), for example, as a VR platform, detailed examinations of multiple investments made be made simultaneously, including the relations between them. In other cases, any amount of physical space may be used to represent the data in VR (e.g., a space of a pre-defined, but located outside). In one example, these controls may include virtual “keyboards,” or other similar controls that can detect user movements (e.g., projecting a laser image of a keyboard onto a tabletop).

In some aspects, the user interface may provide for controls to add other attributes to a point in the 3D space, such as stock information. For example, this may include making stocks that trade easily feel be light and stocks that trade with difficulty feel heavy—e.g., easy to push/pull versus a bit harder to push/pull in VR, in manipulating or navigating through the 3D space.

### BRIEF DESCRIPTION OF THE DRAWINGS

A more complete appreciation of the present advancements and many of the attendant advantages thereof will be readily obtained as the same becomes better understood by reference to the following detailed description when considered in connection with the accompanying drawings. However, the accompanying drawings and their exemplary depictions do not in any way limit the scope of the advancements embraced by this specification. The scope of the advancements embraced by the specification and drawings are defined by the words of the accompanying claims.

FIG. 1 is a schematic diagram of a system for analyzing investment information according to an exemplary embodiment of the present advancement;

FIG. 2 is a schematic diagram of an information processing apparatus according to an exemplary embodiment of the present advancement.

FIG. 3 is a schematic drawing of a mobile device according to an exemplary embodiment of the present advancement;

FIG. 4 is a functional drawing of the investment analysis system according to an exemplary embodiment of the present advancement;

FIG. 5 is an algorithmic flow chart of analyzing investment information according to an exemplary embodiment of the present advancement.

FIG. 6 is a flow diagram illustrating an example process for graphically representing data including a number of values in a multi-dimensional space.

FIG. 7 is a flow diagram illustrating an example process for modifying data through graphical modifications in a multi-dimensional.

FIGS. 8-11 illustrate example multi-dimensional spaces for representing multiple values.

FIG. 12 illustrates an example display of a multi-dimensional space, representing multiple values, with user interface controls for manipulating the multi-dimensional space.

### DETAILED DESCRIPTION

In the following, the present advancement will be discussed by describing a preferred embodiment with reference to the accompanying drawings. However, those skilled in the art will realize other applications and modifications within the scope of the disclosure as defined in the enclosed claims.

In embodiments, any desired network configuration, hardware, programming architecture, or a combination of both may be used to implement a system for analyzing investment information.

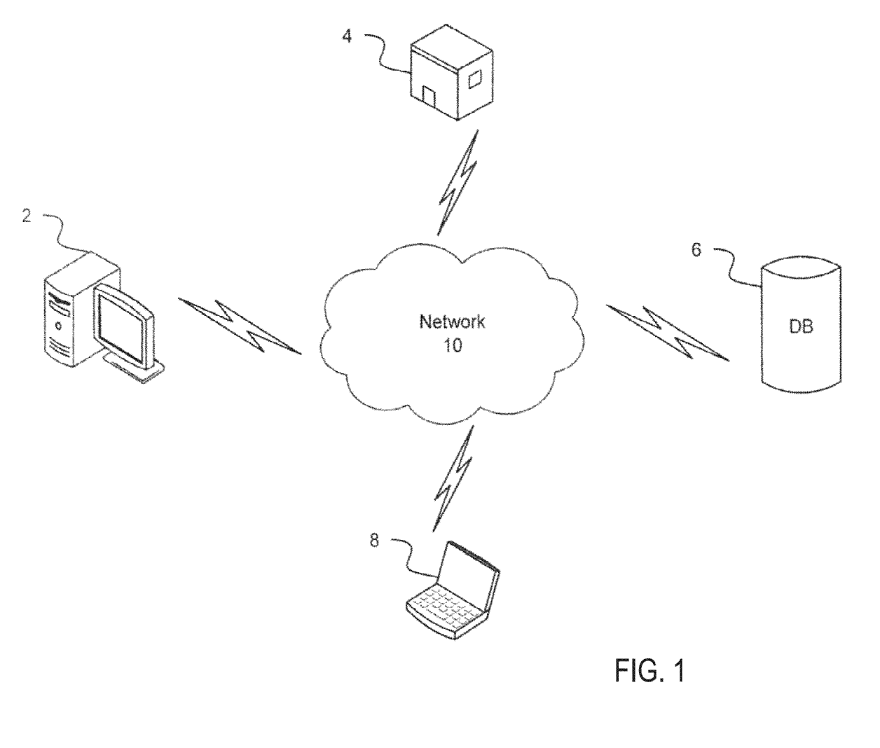

FIG. 1 is a schematic diagram of a system for analyzing investment information according to an exemplary embodiment of the present advancement. In FIG. 1, a computer 2 is connected to a server 4, a database 6 and a mobile device 8 via a network 10. The server 4 represents one or more servers connected to the computer 2, the database 6 and the mobile device 8 via the network 10. The database 6 represents one or more databases connected to the computer 2, the server 4 and the mobile device 8 via network 10. The mobile device 8 represents one or more mobile devices connected to the computer 2, the server 4 and the database 6 via the network 10. The network 10 represents one or more networks, such as the Internet, connecting the computer 2, the server 4, the database 6 and the mobile device 8.

The server 4, the computer 6 and/or the mobile device 8 can be utilized as a central hosting site for the investment analysis system. Users of the computer 6 and mobile device 8 can also access the investment analysis system on the server 4 via network 10. Accordingly, the server 4 may notify users of the investment information through the network 10 to the computer 6 or mobile device 8.

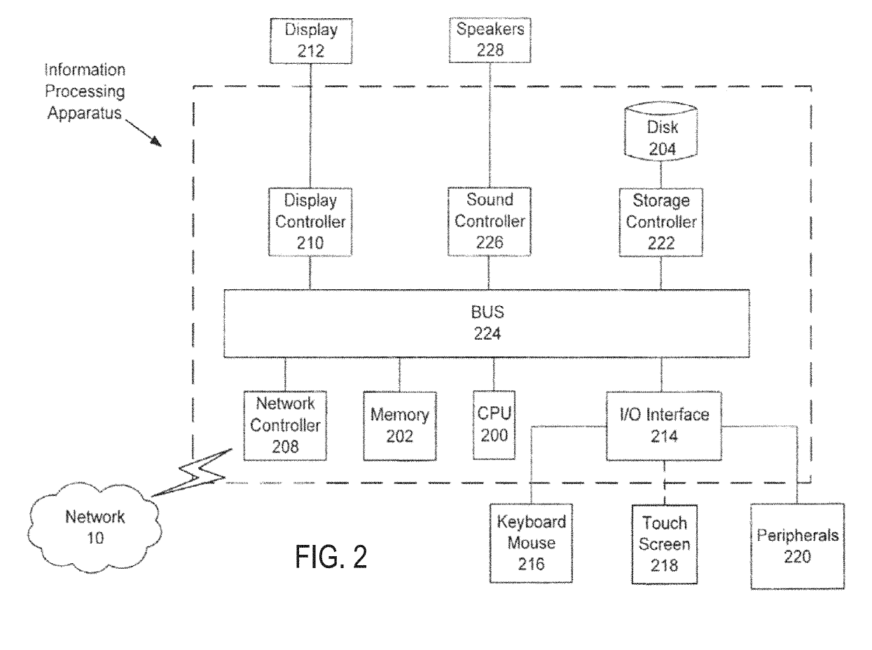

Next, a hardware description of the information processing apparatus for analyzing investment information according to exemplary embodiments is described with reference to FIG. 2. In FIG. 2, the information processing apparatus includes a CPU 200 which performs the processes described above. The process data and instructions may be stored in memory 202. These processes and instructions may also be stored on a storage medium disk 204 such as a hard drive (HDD) or portable storage medium or may be stored remotely. Further, the claimed advancements are not limited by the form of the computer-readable media on which the instructions of the inventive process are stored. For example, the instructions may be stored on CDs, BLU-RAY, DVDs, in FLASH memory, RAM, ROM, PROM, EPROM, EEPROM, hard disk or any other information processing device with which the information processing device communicates, such as a server or computer.

Further, the claimed advancements may be provided as a utility application, background daemon, or component of an operating system, or combination thereof, executing in conjunction with CPU 200 and an operating system such as Microsoft Windows 7, UNIX, Solaris, LINUX, Apple MAC-OS and other systems known to those skilled in the art.

CPU 200 may be a Xenon or Core processor from Intel of America or an Opteron processor from AMD of America, or may be other processor types that would be recognized by one of ordinary skill in the art. Alternatively, the CPU 200 may be implemented on an FPGA, ASIC, PLD or using discrete logic circuits, as one of ordinary skill in the art would recognize. Further, CPU 200 may be implemented as multiple processors cooperatively working in parallel to perform the instructions of the inventive processes described above.

The information processing apparatus in FIG. 2 also includes a network controller 208, such as an Intel Ethernet PRO network interface card from Intel Corporation of America, for interfacing with network 10. As can be appreciated, the network 10 can be a public network, such as the Internet, or a private network such as an LAN or WAN network, or any combination thereof and can also include PSTN or ISDN sub-networks. The network 10 can also be wired, such as an Ethernet network, or can be wireless such as a cellular network including EDGE, 3G and 4G wireless cellular systems. The wireless network can also be WiFi, Bluetooth, or any other wireless form of communication that is known.

The information processing apparatus further includes a display controller 210, such as a NVIDIA GeForce GTX or Quadro graphics adaptor from NVIDIA Corporation of America for interfacing with display 212, such as a Hewlett Packard HPL2445w LCD monitor. A general purpose I/O interface 214 interfaces with a keyboard and/or mouse 216 as well as a touch screen panel 218 on or separate from display 212. General purpose I/O interface also connects to a variety of peripherals 220 including printers and scanners, such as an OfficeJet or DeskJet from Hewlett Packard.

In some aspects display controller 210 may be designed to interface with display 212 and/or one or more other peripheral devices 220 such as virtual reality (VR) or augmented reality devices. These may include devices made by various different companies. As will be described in greater detail below, display controller 220 and/or other components of the system of FIG. 2 may be configured to extract and manipulate data to create new data useful for displaying graphical representations of the data and various relationships between the data.

A sound controller 226 is also provided in the information processing apparatus, such as Sound Blaster X-Fi Titanium from Creative, to interface with speakers/microphone 228 thereby providing sounds and/or music.

The general purpose storage controller 222 connects the storage medium disk 204 with communication bus 224, which may be an ISA, EISA, VESA, PCI, or similar, for interconnecting all of the components of the information processing apparatus. A description of the general features and functionality of the display 212, keyboard and/or mouse 216, as well as the display controller 210, storage controller 222, network controller 208, sound controller 226, and general purpose I/O interface 214 is omitted herein for brevity as these features are known.

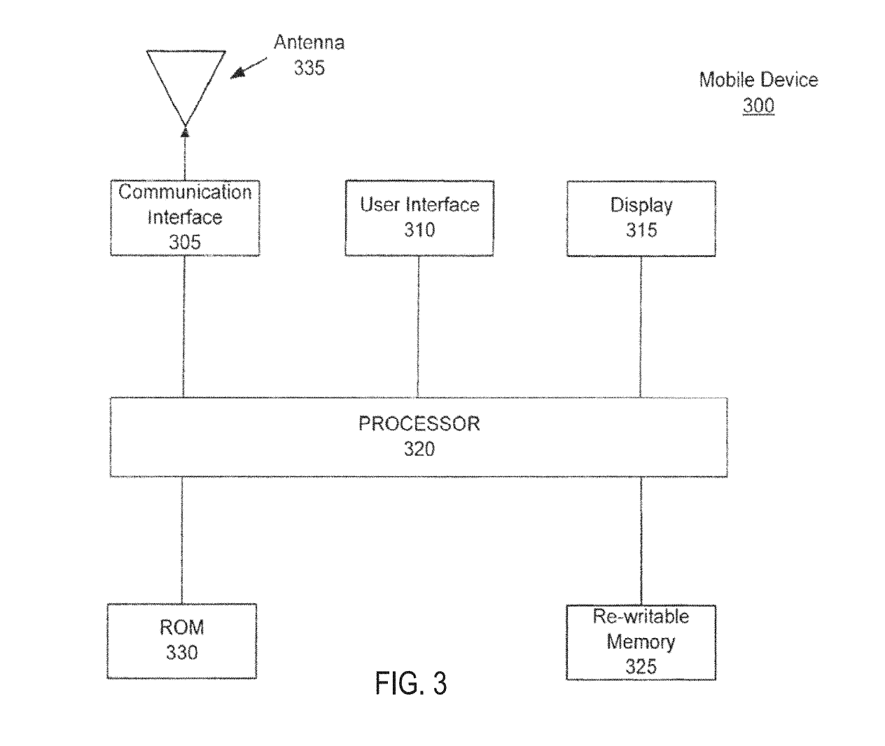

FIG. 3 is a block diagram of the mobile device 8. The mobile device 8, which may be a smart phone such as an iPhone from Apple, Inc. of America, includes a processor 320 used to control the functions of the mobile device 8 and to run applications thereon, such as an electronic address book, internet browser, etc. Processor 320 may be an ARM processor or a processor such as a Core 2 Duo from Intel Corporation of America. Alternatively, Processor 320 may be implemented on an FPGA, ASIC or using discrete logic circuits, as would be recognized by one of ordinary skill in the art.

A user interface 310, which may include a microphone, speaker, touch screen, keyboard or any combination thereof, allows the processor 320 to receive input from a user of the mobile device 300, and a display 315 provides feedback to the user. Display 315 may be a color or monochrome LCD display or any other display that would be recognized by one of ordinary skill in the art.

Mobile device 8 also includes a communication interface 305 and antenna 335 to communicate with other devices, such as the server 4 or another mobile device 8. Further, mobile device 8 may communicate with these other devices wirelessly using the cellular network (including EDGE, 3G, 4G, etc.,) a WiFi connection, a Bluetooth connection or any other wireless form of communication that is known. Mobile device 8 may also communicate through a wired connection to communication interface 305, such as a USB connection.

In some embodiments, mobile device 8 includes read-only memory, ROM 330, to store low-level functions and processes necessary to support core functionality, and re-writable memory 325, which stores an operating system, drivers, applications, application data and user data. Re-writable memory 325 may be dynamic or static random access memory (RAM), FLASH memory, EEPROM memory, and the like. Further, portions of the re-writable memory 325 may be removable.

For example, re-writable memory 325 may store an application for communicating with server 4 to identify mobile device 8 and to provide the server 4 with access to data stored therein. Such application may be downloaded, via any of the communication methods described above, from the server 4, from a software repository or from an online store, such as the App Store from Apple, Inc. of America. Further, such an application may be an electronic address book, or electronic personal information manager (PIM). However, the application may also be a plug-in for an electronic address book or PIM already installed on mobile device 8, a background application, driver and the like.

As one of skill in the art would recognize, the above descriptions of the server 4 and mobile device 8 are merely examples and other server configurations and mobile devices may be used without departing from the scope of the present advancements.

According to some embodiments, a “module” refers to hardware architecture or one or more programming architectures, or a combination of both, configured to perform one or more designated functions.

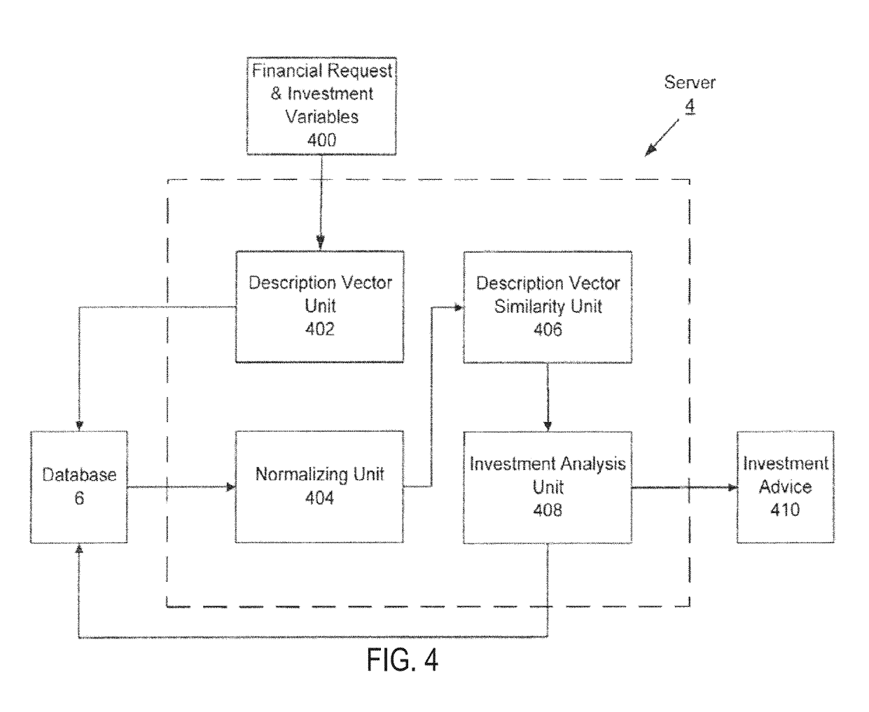

FIG. 4 describes the functionality of the investment analysis system according to one embodiment of the present advancement. FIG. 4 illustrates investment variables and a financial request 400, the database 6, the server 4, the investment advice 410, a description vector unit 402, normalizing unit 404, description vector similarity unit 406 and an investment analysis unit 408. The description vector unit 402, normalizing unit 404, description vector similarity unit 406 and an investment analysis unit 408 are illustrated within the server 4 but in other embodiments could be included within the computer 6 or the mobile device 8. Investment variables and a financial request 400 relating to an investment, or financial indicator, are received from a user depending on the investment information the user wants to obtain. Example investment variables 400 include P/E ratios, debt to equity, total sales, and temporal resampled risk. The financial request represents a request from the user to obtain certain financial information. A variety of non-limiting examples of financial requests are described in detail later. The investment variables and financial request 400 are then transmitted to the server 4 via the network 10 as described in FIG. 1.

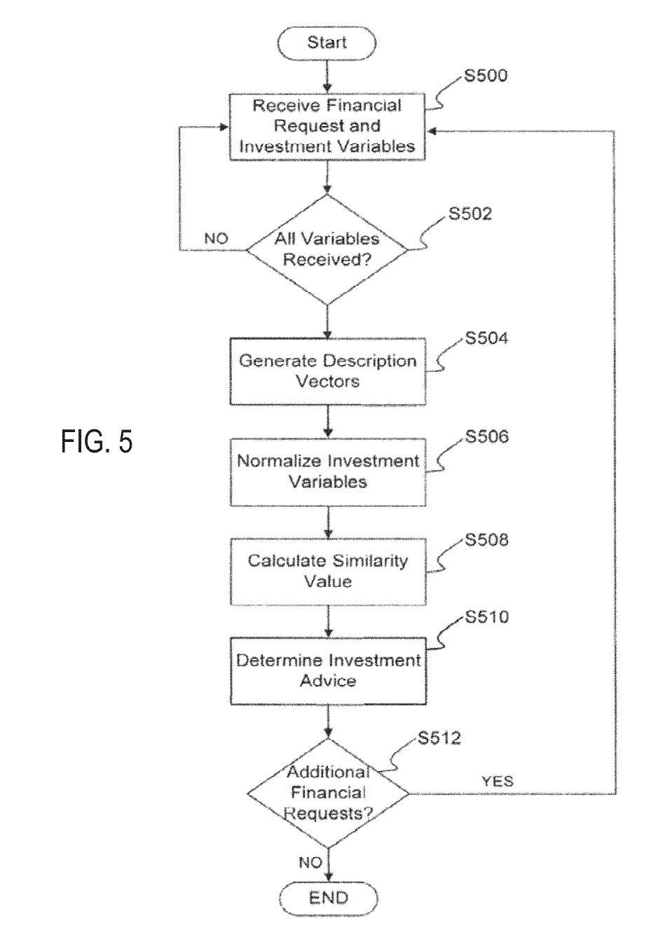

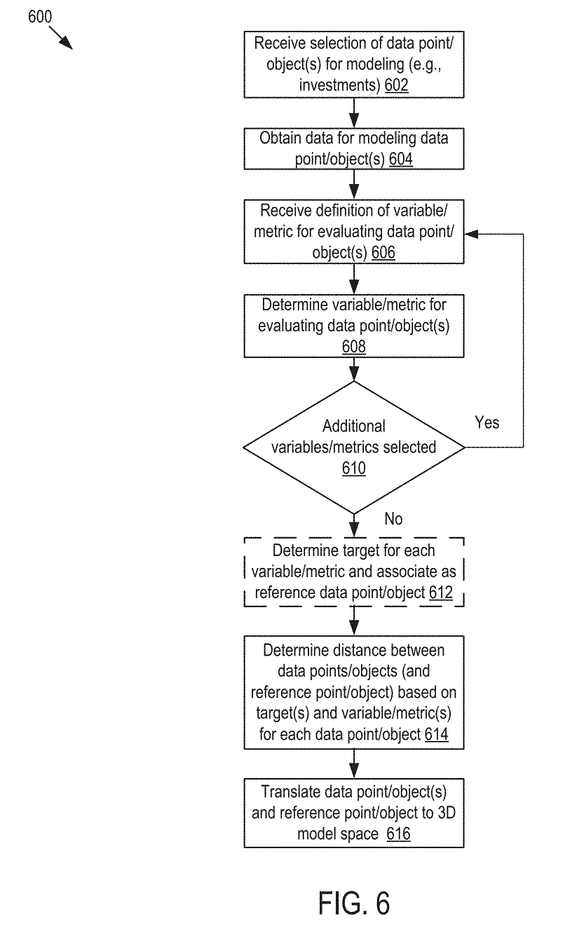

The description vector unit 402 of the server 4 defines a description vector based on the investment variables and the financial request 400. The description vector can represent a multidimensional point in multidimensional space and contains the investment variables 400. The description vector defines what type of investment information, such as risk or reward information, the user is seeking to obtain for his or her portfolio needs. More information with respect to the description vector is provided later with respect to FIGS. 5 and 6.

The normalizing unit 404 of the server 4 normalizes all of the investment variables 400 of the description vector defined by the description vector unit 402. Normalization is required so that all of the investment variables 400 have an equal weight with respect to each other when investment calculations are performed. One type of normalization is 1/N, where N is the number of investment variables 400. Another type of normalization is to use the standard deviation of all the information in database 6. For this type of normalization, the information analyzing system calculates the standard deviation for each investment variable 400 contained in the database 6 and then divides the investment variable 400 of the particular investment by the standard deviation. For example, if the user selects IBM as a particular investment and chooses the P/E Ratio as one of the investment variables 400, the investment analysis system locates all of the P/E Ratios in the database 6, calculates the standard deviation, and then divides the P/E Ratio of IBM by the standard deviation to obtain a normalized value.

The present advancement, however, does not require the input investment variables to be equally weighted. As long as the sum of all the normalization weights is 1, different investment variables 400 could have different weights. Any additional description vector being compared to the description vector defined by the description vector unit 204 would also have to be normalized to keep calculations consistent. More information with respect to the normalizing unit 404 is provided with respect to FIG. 5.

The description vector similarity unit 406 calculates the similarities between description vectors created by the description vector unit 402 and normalized by the normalizing unit 404. As described later, at least one way to determine the similarity between description vectors is to calculate the Euclidean distance between the description vectors. However, another metric for determining the similarity is to use an absolute value metric or any other metric defined by the user of the investment analysis system. The results of the description vectors similarity unit are then transmitted to the investment analysis unit 408.

The investment analysis unit 408 analyzes the results of the description vector similarity unit 406 to provide the user with investment advice based on the investment variables and the financial request 400 defined by the user. To do this, the investment analysis unit 408 compares similarity information from the description vector similarity unit 406 based on what type of investment information the user is interested in obtaining for his or her portfolio. Non-limiting examples of investment information include a list of a best or worst investments, a comparison of investments, and risk and reward information. More information on the investment information determined by the investment analysis unit 408 is described later with respect to FIG. 5.

The investment advice 410 of the investment analysis unit 408 are provided to the database 6 to be stored for possible later analysis and are provided to the user via at least a computer 2 or mobile device 8 as described in FIG. 1.

FIG. 5 is an algorithmic flow chart of analyzing investment information according to an exemplary embodiment of the present advancement. The process of analyzing investment information starts at step S500 by having a user input a customized ranking of factors, or investment variables 400, relating to the investment (p/e ratios, debt to equity, etc), and a financial request 400. The system then determines whether all the variables have been received at step S502. If NO at step S502, the system continues to accept investment variables 400 until the user has finished. If YES at step S502, the system proceeds to step S504 to generate a description vector based on the investment variables and the financial request 400.

The description vector DV generated by the description vector unit 402 is defined as follows. DV=(s1, s2, s3, . . . , sn), where s1 through sn are investment variables 400 that describe an investment or benchmark in question. Therefore, if the user wanted to measure the risk of a single stock and determines that the most important factors are the p/e ratio, the 21 day resampled risk of the maximum drawdown exceeding 10%, and the Quick Ratio, then the description vector for this particular stock, i.e. for this particular calculation, would be an “Investment Risk Vector” defined as IRV=(p/e ratio, 21 day resampled risk of the maximum drawdown exceeding 10%, Quick Ratio). A corresponding “Benchmark Risk Vector” would be defined as BRV=(p/e ratio, 21 day resampled risk of the maximum drawdown exceeding 10%, Quick Ratio). While both vectors contain the same investment variables 400, the values of the investment variables 400 will likely be different based on the corresponding value of each investment variable 400 in the database 6 with respect to the investment or benchmark. Once the description vector is defined, the process proceeds to step S506 to normalize each of the investment variables 400.

The investment variables 400 must be normalized to ensure they each provide the appropriate amount of weight to the investment analysis calculations. For example, the absolute value of a p/e ratio is generally in the tens or twenties. The absolute value of a 21 day resampled risk, however, is between zero and 1. If the two variables were not normalized, then any future calculation would be almost entirely dominated by the p/e ratio.

One option is for the user to specify how to normalize each variable based on the user's needs. However, a natural, default, normalization for each piece of data is supplied for the ease of the user. As noted above, one such natural normalization is to use the standard deviation of all such pieces of information in the database 6. So, for example, if the user requested analysis on a particular stock, and the user's choices were the p/e ratio, the p/s ratio, and the chance of a 5 day maximum drawdown exceeding 5%, all the p/e ratios would be located in the database 6, their standard deviation would be calculated, and then that particular stock's p/e ratio would be divided by this standard deviation. Then all the p/s ratios would be located in the database 6, their standard deviation would be calculated, and this stock's p/s ratio would be divided by that standard deviation. This process is repeated until all the investment variables 400 of the description vector are normalized.

Returning to the description vector, non-limiting examples of the description vector include an Investment Risk Vector, Benchmark Risk Vector, Investment Reward Vector and an Benchmark Reward Vector. The description vector can also be any other vector chosen by the user. As such, the names “Benchmark Risk Vector”, “Benchmark Reward Vector”, “Investment Risk Vector” and “Investment Reward Vector” are for convenience and the user is free to specify any number of vectors with customized naming conventions so as to make whatever comparison the user sees fit between whatever instruments, portfolios or groups the user wants. The Investment Risk Vector IRisk is defined as follows. IRisk=(IRisk1, IRisk2, IRisk3, . . . , IRiskn), where IRisk1 through IRiskn are the normalized investment variables 400 that describe the investment in question. For example, IRisk1=p/e ratio, IRisk2=21 day resampled risk, IRisk3=total sales of company/total sales in industry, etc, to IRiskn. Alternatively, IRisk1=5 day resampled risk of maximum drawdown >5%, IRisk2=chance of hitting a fixed stop loss of 3% over a one month period, etc, to IRiskn. The investment could be anything from an individual financial instrument such as a stock, to a group of financial instruments such as a group of stocks, to an entire investment portfolio made up of any number of financial instruments such as stocks, bonds, mutual funds, commodities, options, OTC derivatives, currencies, contingent claims, derivatives, balance sheet items, options, futures, exchange traded instruments, and over the counter instruments.

The Benchmark Risk Vector Brisk is defined as follows. BRisk=(BRisk1, BRisk2, BRisk3, . . . , BRiskn) where BRisk1 through BRiskn are the same investment variables 400 as IRisk1 through IRiskn, but for the Benchmark rather than the Investment if the Benchmark Risk Vector BRisk is used in comparison to the Investment Risk Vector. A Benchmark is a standard against which the performance of a security, mutual fund or investment manager can be measured. Generally, broad market and market-segment stock and bond indexes are used for this purpose. For example, the Benchmark could be a recognized benchmark like the S&P 500, it could be a sector index, it could be an ETF, or it could be some custom composite created by the user.

The Investment Reward Vector IReward is defined as follows. IReward=(IReward1, IReward2, IReward3, . . . , IRewardn), where the investment variables 400 are variables that the user thinks affect the expected return of the investment. The investment could be for a stock, a portfolio, or a mixed bag of various kinds of investments. It should be noted that the Investment Reward Vector should not be the same vector as Investment Risk Vector IRisk. The Investment Risk Vector IRisk represents what the user thinks of as the financial information that goes wrong, or might go wrong, or that which indicates an elevated level of risk. IReward represents that financial information which the user thinks might go right thereby providing a favorable return for the user.

The Benchmark Reward Vector is defined as follows. BReward=(BReward1, BReward2, BReward3, . . . , BRewardn) where the investment variables 400 correspond to the investment variables 400 defined in the Investment Reward Vector IReward if the Benchmark and the Investment Reward Vector IReward are being compared. It should be noted that BReward represents the “ideal” investment according to the user. For example, if the user is a stock investor and is interested in value, the user may think the best kinds of investments are those where the p/e ratio is less than 10, the price/book is less than 1, the current ratio is greater than 1, and the profit margin is greater than 5%. Thus, the user would create a BReward with those four investment variables 400 and normalize the investment variables 400. A comparison of proposed investments to this “ideal” investment will be described later.

Returning to FIG. 5, after the investment variables 400 have been normalized at step S506, the similarities between the description vectors are calculated at step S508. There are different ways of defining a similarity between two description vectors. One option is to take the Euclidean distance between two multidimensional vectors generated by the description vector unit 402. This would be represented by, for example, ∥IRisk−Brisk∥ or ∥IReward−BReward∥, which represents taking each normalized investment variable 400 from each description vector generated by the description vector unit 402, subtract one from the other, square the result, sum them together, and take the square root. For example, to calculate the risk of an investment, the following calculation is performed: (IRisk1−BRisk1)̂2+(IRisk2−BRisk2)̂2+(IRisk3−BRisk3)̂2+ . . . +(IRiskN−BRiskN)̂2. The square root of the resulting sum is then calculated to obtain the similarity value.

Another method of calculating the similarity is by using an absolute value similarity metric. Using the absolute value metric, each normalized investment variable from each description vector generated by the description vector unit 402 is subtracted from one another and the resultant values are added to obtain a distance between the description vectors. The absolute value of the distance is then determined to obtain a similarity value. For example, to calculate the risk of an investment, the following calculation is performed: |(IRisk1−BRisk1)|+|(IRisk2−BRisk2)|+|(IRisk3−BRisk3)|+ . . . +|(IRiskN−BRiskN)|.

It should be noted that when more variables are added, the absolute value of the result will increase. While the results for each calculation will be unaffected by this, it might cause some confusion to a user. Therefore, one non-limiting example to keep intuition correct from one similarity calculation to the next for the user, is to divide each “similarity” result by √N, where N is the number of variables in the vector.

Investment advice is then determined by the investment analysis unit 408 based on the results of step S508 and the types of description vectors compared. Provided below are non-limiting examples of investment advice determined by the investment analysis unit 408 based on a variety of financial requests 400 received that relate to investment information. For example, upon receiving a financial request to identify the risk of an investment, the investment analysis system calculates the similarity between the investment risk vector and the benchmark risk vector. For this analysis, the greater the number calculated from the similarity between the investment risk vector and the benchmark risk vector, the higher the risk of the investment.

An investment comparison can also be calculated to provide the user with information on how the current investment compares to an ideal investment. An ideal investment is a predefined investment by the user based on the user's financial requirements. This is determined by calculating the similarity between the investment reward vector and the benchmark reward vector. For this analysis, the smaller the number calculated from the similarity between the investment reward vector and the benchmark reward vector, the closer the current investment is to the ideal investment and therefore the better the current investment.

For a given group of investments, a list of the best and worst investments out of the group can be calculated. This list is determined by calculating the risk and reward for each investment in the database 6. Next, for each investment, the ratio “(1/reward)/(risk)” is calculated and the investments can be ranked by this number. Accordingly, the investments with the highest ranks are the best and the investments with the lowest ranks are the worst. The best or worst investments can be any type of investment meeting predetermined constraints by the user. For example, a best investment could be one which makes the most short term gain whereas the worst investment could be one with the quickest loss short term.

Alternative investments that have a similar risk profile to the current investment can also be calculated. This analysis is performed by calculating the risk for all the investments in the database 6 and finding those investments with a risk value that is closest to the risk value of the current investment. Similarly, alternative investments that have a similar reward profile to the current investment can also be calculated. This analysis is performed by calculating the reward for all the investments in the database 6 and finding those investments with a reward value that is closest to the reward value of the current investment.

For a user interested in one investment, better investments with similar risk profiles can be calculated. First, and as explained above, all other investments that have a similar risk profile to the one investment are located from the database 6 and their reward values are calculated. These investments are then ranked by the equation “(1/reward value)/(risk value)” to determine the better investments.

A user can also build a portfolio with an optimal risk/reward. In this case, an optimization routine would find the portfolio that maximized the “(1/reward)/risk” ratio subject to user defined constraints. The user defined constraints can represent certain filters within a portfolio with respect to the investment information. For example, the user could define constraints such that no single investment can have more than a 10% weight in the portfolio, the top 5 investments must account for at least 25% of the total weight in the portfolio, currencies must represent a fraction between 3% and 5% of the portfolio, and gold must represent between 1% and 3% of the portfolio. To define best portfolio, similarity to a benchmark is used for optimization.

In other words, for a portfolio, there would be a weight (wi) for each investment. Each variable that went into either the investment risk vector or the investment reward vector would be weighted by that weight (wi) as follows:

IReward=w1*IRewardV1+w2*IRewardV2+w3*IRewardV3 and so on, with the sum of the w's=1, where each of the IRewardV's is a vector. BReward is set to the user's idea of the ideal investment. IRisk=w1*IRiskV1+w2*IRiskV2+w3*IRiskV3 and so on, while having the same w's as IReward. An optimization routine to maximize (1/∥IReward−BReward∥)/(∥IRisk−BRisk∥) by varying the w's, subject to constraints, would then be used to rank the various investments based on the user constraints.

In another example according to the present advancement, when trying to choose amongst 10 stocks that have been identified via a stock screen or some other associated method, it is important to know which of these stocks gives the most return with respect to the risk. If it is believed that the best stocks have Earnings Growth in the current quarter of 50% to 75%, Annual earnings growth over the last 3 years of 15%-25%, and as close to new highs as possible, the BReward vector is defined as “62.5/normalization (investment variable₁), 20/normalization (investment variable₂), 0/normalization (investment variable₃).” The value 62.5 represents the midpoint of 50 to 75, the value 20 represents the midpoint of 15%-25%, and 0 represents a stock trading at a new high, ie, ((current price−highest price)/current price)/normalization (investment variable₃). The same process is then repeated for each of the ten stocks to get their IReward vectors. The ten distances, or similarity values, are then calculated as dReward1 through dReward10 by obtaining the reward similarity values between IReward1 and BReward1, IReward2 and BReward2 and so forth through IReward10 and BReward10.

Similarly, if it is believed that the most worrisome risks are such concerns as the risk that this stock will fall more than 10% in the next week, the probability that this stock will hit a stop loss placed 15% away, and the risk that this stock will fall more than 20% from a purchase price at any time over the next year, the IRisk vector is defined as the normalization of the above noted risk values. Further, the BRisk vector with respect to the Benchmark i.e. the S&P 500 contains the same investment variables 400. Again, the ten distances, or similarity values, are then calculated as dRisk1 through dRisk10 by obtaining the risk similarity values between IRisk1 and BRisk1, IRisk2 and BRisk2 and so forth through IRisk10 and BRisk10.

Next, the ten Reward/Risk statistics are calculated as “(1/Reward Similarity Value[i])/Risk Similarity Value[i]”, with i going from 1 to 10. Given the above-noted considerations and based on the results, the highest ranked stock would be the best and the lowest ranked stock would be the worst. For example, the highest ranked stock has the lowest calculated value and the worst stock has the highest calculated value based on the equation: “(1/Reward[i])/Risk[i].”

In another example according to the present advancement, sometimes the user is not worried about risk but is instead interested in the stocks that best match a stock display screen of the user. In other words, the user may be interested in stocks that best match a stock display screen defining that earnings growth must be >60% in the last quarter, sales growth must be >25% in the last quarter, and average annual earnings per share must be >25% over the last 3 years.

A problem with this scenario is that a user will typically just adjust the values displayed on the stock display screen screens until a certain number of stocks come up when no stocks meet the original stock display screen criteria. This causes problems because often the user is looking for a “common-sense” or “close-enough” match to the screen and adjusts the screens, which can move the user away from obtaining a meaningful screen match. In other words, there isn't much of a real difference between a stock that grew at 25% and one that grew at 24.5%. For this case, BReward is defined as (60,25,25).

Next, all the stocks in the database 6 are processed and for each one the IReward is calculated as “min(Earnings Growth,60), min(Sales Growth,25), min (Average Annual Earnings,25).” Therefore, criterion that are specified as “must be greater than” or “must be less than” are replaced by any numbers that exceed (are less than) the threshold by the threshold. In other words, if the earnings growth is more than 60, it is replaced with 60. As such, if there are N stocks, N distances N[i] are calculated between BReward[i] and IReward[i]. When the N distances N[i] are ranked in ascending order, the lowest N's have the best match to your criteria. Therefore, the present advancement provides a more useful and reliable stock screen than those provided by conventional methods.

According to another example of the present advancement, assume that a user is a portfolio manager who owns a variety of stocks and has the S&P 500 as a benchmark. Because of this situation, it may seem that the user is massively correlated to the S&P 500 and is a closet indexer. This is a problem because customers may ask why they are paying money for services when it seems like the user is just following the S&P 500. While this may just be a coincidence, there needs to be a way to prove the coincidence to the customer. One solution afforded by the present advancement is to pick a set of salient investment variables 400 such as the P/S ratio, the P/E ratio, average daily trading volume, and market cap relating to a financial request to determine a financial correlation. The weighted average P/S, P/E, average daily trading volume and market cap of the user's portfolio (weighted by their percentage weight in the portfolio) is then calculated based on their values in the database 6 and are compared to the values from the database 6 of the same input variables 400 with respect to the S&P 500. In other words, the BReward and the IReward are calculated and compared. If they're substantially different than zero, then the high correlation to the S&P 500 has nothing to do with being a “closet indexer” and the customer's concerns can be allayed.

According to another example of the present advancement, the user may determine that a particular stock used to be a “value” stock but is now a “growth” stock because the stock has raised in value significantly. As such, the user may have a problem convincing an investment committee to sell the stock unless the user can show that the stock should not be in the user's portfolio.

To solve this issue, a BReward Value and a BReward Growth are calculated by the investment analysis system. Using these calculations, the user can demonstrate that three years ago when the user bought the stock, its BReward Value number was much smaller than its BReward Growth number. However, now the situation is reversed in that the BReward Value is very much larger than BReward Growth. It is important to note in this situation that the BReward Value and BReward Growth vectors need not have the same factors thereby making comparisons very simple for users well versed in the differences between value and growth stocks.

According to another example of the present advancement, assume a user wants to invest in companies local to where the user lives because the user believes he would have a better understanding of information with respect to those local companies from reading local newspapers, talking to local company employees, etc. However, determining which companies are local can be troublesome using conventional methods. A user must struggle with an overwhelming amount of search options to determine whether a company is local such as a company's official address, local revenue, the number of employees that live near the user, the percentage of the company's suppliers that are local, and the percentage of the company's customers that are local. Therefore, unless the user takes all these things into account, the user will find it difficult to get useful information with respect to his investment needs.

The use of description vectors of the present advancement overcomes this problem. First, all of the above-noted information with respect to each company is collected and stored in the database 6. For example, the distance of “headquarters” of a company from the geographic center of where the user lives, the percent of the company's employees that work within 25 miles of where the user lives, the percentage of the company's revenue that is generated in the state where the user lives, the amount of the company's supplies that come from companies in the user's state, and the percentage of the company's revenue that comes from other states can be included in an BReward description vector such as BReward(0,100,100,100,100). This value is then compared by the investment analysis system to the IReward of every company in the database 6 using the same variables as those in the BReward description vector to calculate the distances therebetween. Based on the results and the customization and calculation by the investment analysis system, the user is provided with information describing that the lowest distances represent the most “local” companies.

According to another example of the present advancement, the best stocks in the “energy” sector can be calculated by customizing a BRisk and BReward and performing the above-noted procedures for a ranking. If a user is interested in stocks that are “like”, or “closest” to Southern Co, the user determines user-customized investment variables 400 such as Debt/Equity, Price/Sales, Quick Ratio, and Market Cap and creates a BReward with these investment variables 400 for Southern Co. These results are then compared by the investment analysis system to all the IRewards in the database 6 and the top N matches can be determined. Similarly, if a user is interested in stocks like “RHAT”, but wants Risk to be taken into account, the user defines investment variables 400 such as market cap, debt ratios, share numbers, common owners, financial metrics, and similar past performance for Reward (call these x1, x2, x3, . . . xn) and appropriate investment variables (y1, y2, y3 . . . , yn) for Risk. The user then creates a BRisk description vector with y1 through yn and a BReward description vector with x1 through xn. The normal above-noted ranking procedure is then applied to determine the best stocks that are like “RHAT.” Further, if the user is interested in stocks that are like “RHAT” but only within the “technology” sector, the investment analysis system follows the above procedure while restricting the stocks in consideration to “technology” stocks.

According to another example of the present advancement, a user may wish to determine whether his mutual fund is exhibiting “style drift” based on the managers investment strategy. Style drift is when a manager has bad performance and changes his method of managing his fund to try to catch up. This is usually a disaster for the investor. To solve this problem, the user takes a portfolio of the fund from a past disclosure and picks the salient investment variables 400 (these will depend on the type of fund). The investment analysis system then determines the old IReward and BReward based on these past investment variables 400 values stored in the database 6 and calculates the distance. The investment analysis system then takes the portfolio of the fund today and makes the same IReward and BReward but with the current values. At this point the investment analysis system can inform the user whether the distance has changed appreciably. The investment analysis tool can also repeat this process for every past quarter to determine whether the distance calculation suddenly spikes up or drifts up every quarter.

According to another example of the present advancement, a user that wants to buy government debt can determine how much riskier that government debt is as compared to other government debt. For example, assume the user wants to buy Italian government debt but believes that German government debt should be taken to be “risk free”. The user then wants to know how much riskier the Italian government debt is as compared German government debt. Here, the user determines that the investment variables 400 are “percent of debt maturing in the next year”, the “debt/GDP ratio”, the “current account deficit as a percent of GDP”, and “percentage of debt held by foreigners”. The investment analysis system then constructs the BRisk with German statistics and the IRisk with Italian Statistics. The calculated distance measures show how much riskier Italian Debt is versus German Debt.

According to another example of the present advancement, the user may want to buy GE bonds and determine how much riskier the GE bonds are than F bonds? If the user believes that IBM bonds are almost “risk free” and should be used as the benchmark, the user picks salient investment variables 400 and the investment analysis tool constructs IRiskGE, IRiskF and BRiskIBM and compares the distance of IRiskGE versus BRiskIBM with IRiskF versus BRiskIBM. The one with the highest distance is the riskiest.

According to another example of the present advancement, the user may believe that countries with the following set of characteristics (S) have currencies, or stocks, that will appreciate. The investment analysis system can then provide the best investments from a list of countries in the database 6 by generating BReward and IReward and ranking by ascending order of distance.

Referring back to FIG. 5, once the investment advice is returned, it is determined whether there are any additional financial requests at step S512. If YES at step S512, then the process returns to step S500 to receive different investment variables and financial requests 400. If NO at step S512, the analysis process is completed and the process ends.

According to one embodiment of the present advancement, any investment information determined by the analysis investment system is organized and stored virtually in a plurality of folders. For example, analysis results can be stored on a recording medium of a PC or in the database 6 connected to the network 10. A user can then use his computer 2 or connect to the network 10 to obtain previously calculated investment information based on previously customized description vectors.

Websites hosted by servers 4 can also provide users with online access to the features afforded by the analysis investment system. These websites provide general access features to all users as well as increased access and functionality when a user registers with the website. A user who is registered could access old financial investment information based on previously customized description vectors via a search of the virtual folders. This old investment information could then be compared against current values obtained by running the previously customized description vectors. A user can also use customized description vectors to determine investment information based on previous market conditions at a specific date or automatically update the old investment information based on current market conditions.

Though the above discussion has been made with reference to the stock market, other financial markets or investment structures may also be used without departing from the spirit of this advancement.

The techniques described above are useful in determining the best match of an investment option when compared to an ideal or target value, or for comparing investment information without a target (e.g., landscape analysis). The same principles can be applied to other types of information, including sports performance, such as on the team, league, or player level. The described techniques can be used to find all those situations in the past data that are “similar” to the current situation, and rank that data by their similarity to the target or ideal. Using past data, predications can then be made for future performance. In some cases, comparison made between the data can be between current versus past situations, or past versus past or present versus present situations.

A primary difference between this idea, and what is currently done in the professional sports, is that the state of the art in sports analysis is to find “same” situations. So, how many yards will an NFL team gain offensively, if it has a top ranked QB, and he's facing a bottom ranked defense? How often does a team win the game when its yards/pass attempt are greater than 7? And so on. This will obviously not scale to additional variables, because as more variables are added, less and less past examples are available for comparison.

For example, how often does a team win the game when its yards/pass attempt is greater than 7, it's yards/rush is less than 3.5, its defense is in the bottom half of the league rankings, the temperature is below 45 F, the game is at home, and the other team is using its second string safety? Under this hypothetical example, it's unlikely that there are any past situations to draw from for direct comparison.

But, a similarity metric can be created that compares this situation to every past situation and found those that are similar. For example, there may be past situations where all the criteria are met but the temperature was 51 F. Or, the criteria were met but the game was away, not home. Or it was a first string safety, the temperature was 70 F but otherwise everything was the same. Using the similarity metric, it is possible to rank all past situations by their overall similarity to the situation in question. And by definition then, the shorter the distance, the higher the similarity. This information can then be used to predict future performance based on those past similarities. For example, a weighted sum of all past futures, would make a forward prediction. Or a distribution of possible futures could be output along with their probabilities of occurrence. A “fair value” for a bet could be computed and under and overvalues bets could be found. The possible futures would be of interest to the announcers and commentators because they would greatly inform their opinions and commentary. The possible futures would also be of great interest to coaches that were game planning and/or calling the game in real time.

One of the major issues in statistics is the issue of nonlinearity. What this means is that quite often, there will be a relationship between one or more variables but yet, traditional analysis (which essentially assume linearity) doesn't pick it up. For a concrete example, think of buying a stock that's fallen a lot. As a general rule, it isn't a good idea to buy stocks that have fallen, because they will tend to keep going down. However, it's quite common to reason, “the stock's fallen, and so ordinarily it wouldn't be a good idea to buy it, but look, it's gone down so much and for so long that it might just be a good buy.” This is an example of a nonlinearity—the straightforward relationship, “don't buy as it goes down” has become, “don't buy as it goes down but if it goes down a lot and for a long time, consider it.” What this example illustrates is that human decision making is rife with: i) dealing with nonlinearities; and ii) pattern recognition. In the above example, a pattern is recognized: “if it goes down a lot, maybe you should buy it”.

A similar principle occurs in sports. For example, a coach could think: “the team with the higher yards per pass attempt wins 75% of the time, but we aren't that good at passing, so perhaps we should run the ball. [So far, linear thinking]. But, the other team's pass defense is really bad, we are at home, and they're a cold weather team coming to a hot part of the country, so maybe it would be good for us to game plan for a lot of passes.” This is nonlinear thinking and pattern recognition. Obviously, in the past, this coach has had experiences that have informed his decision making and he recognizes the similarities between the current situation and his past experience, which he is using to reason via induction.

Sports statistics by and large help with linear problems. For example, concerning football, the side with more yards/pass attempt wins 75% of the time; a side with a turnover differential of +1 wins 68% of the time, a side with a turnover differential of +2 wins 82% of the time, a side with a turnover differential of +3 or more wins 93% of the time; a side with a net field position advantage of 2 yards wins one extra game per season, and so on. But, coaches generally consider tens of variables, such as weather, what kind of field it is, time difference, how statistically strong/weak their defense/offense is, the other team's points per scoring opportunity, number of penalties we have in a game versus them, how many personal fouls, etc. To manage this large amount of variables, they use their past experience to adjust their base expectations to the current game and matchup.

The same thing has to be done by a fantasy player. Which running back should I play today? The one with the highest yards/carry? The guy with the most outside runs? The one who does best on grass fields? They guy with the lowest number of fumbles/carry? And again, a fantasy player takes all these variables, his past experience, and tries to pick that lineup that he thinks maximizes his points for the upcoming matchup.

The current technology, described herein, can solve all of these problems. It's applicable to any sport. It automatically handles nonlinearities. It allows as many variables as a person wants to all be simultaneously considered. It automatically draws from past experience. It provides precise numerical support for each decision for any number of input variable for any sport.

The idea is the user picks those statistics he or she thinks are relevant to his question [or they can be pre-picked—different statistics for different questions—or, most likely, both]. For example, the following statistics are chosen: yards/pass attempt, temperature of the game, the type of field, the rank of the defense in points/game allowed, the number of defensive penalties, and the number of offensive personal fouls. This is 6 variables. As described herein, a vector with these 6 variables may be created, for example, by an application. It then goes into all past games and finds those games that most closely match this vector: that is, their total distance from 6 variables is the smallest (i.e., they're the best matches). The results of those past matches are likely outcomes for the current game. This principle: i) is analogous to what skilled players and coaches do: they use their experience; ii) fast to implement on a computer; iii) automatically handles as many variables as available; and iv) gives a sensible answer even when (as is likely if many variables are being considered) there are no past situations that are the same.

This procedure can then answer any question that the user poses: who might win, which side might run more, how will the temperature affect the passing game, which defense will score more points, etc. This has the potential to be of immense use both to coaches and fantasy fans.

This procedure can also be adapted as an in game decision support system for a coach, from football to baseball and other sports. The system can go back through a database of all past games (or a subset if you so choose) and find those games that most closely match the current situation, and provide results of what happened in the past in similar situations. Similarly, it can be used to inform decisions that are made before a game stats, such as helping a coach to decide on a best lineup and batting order before the game even begins. Is it really best to put your home run hitters at positions 3 and 4 in the batting order? Should the conditions that obtain at the start of the game (any number of variables that you think are important: from size of field and temperature to the ERA of the opposing pitcher and the on base percentage of the opposing team's leadoff hitter) affect your starting lineup and batting order? If so, how? The range of questions that can be answered is limited entirely by the imagination.

In another example, the systems and techniques may be used to show support for decisions that are challenged in the future. Suppose you are the coach of a football program that has made controversial decisions in the past and the athletic director and alumni are unhappy with you. The system will make it possible for you to show that your decisions were in accord with past experience: in similar situations in the past, the decisions you made were the right ones. Or imagine you are the athletic director trying to decide if to fire a losing coach: did he not have enough talent, or did he make bad decisions during games? The system will help you figure that out.

Or cricket, the second most popular sport in the world. Is it really true that you should put your best batsman in at #3? Is that true whether you bat first or second? Is that still true if you are chasing a total or setting at total? What about if it's a short form match versus a long form? Is your highest average batsman really your best or does he mostly make his runs in low pressure situations, and if so, should you send him higher up the order or lower? Is it a good tactic for a right hand bowler to bowl “around the wicket” to a left handed batsman who is well set, and on a score of 33? Do batsmen bat differently when getting close to a score of 50 or 100 because those are big psychological milestones? If so, how can you bowl or set your field to take advantage of this difference? When should the wicket-keeper stand up to a fast bowler and what's the success rate of this tactic? Is it really true that in a limited overs match you should have your faster bowlers bowl the final overs? If so, which types are most successful: swing, seam, or fast? Does the size of the ground change whether or not you should think about using your slower bowlers at the end? What about temperature and condition of the pitch?

As illustrated above, the granularity and focus of the data and analysis, is completely configurable, only limited by the data that is available. The system can automatically adjust and adapt to give sensible answers that accord with human intuition and expertise. It produces a precise, quantifiable result for support for decisions and/or to make them in the first place. It can quantify and support making one decision versus another with a precise measurement.

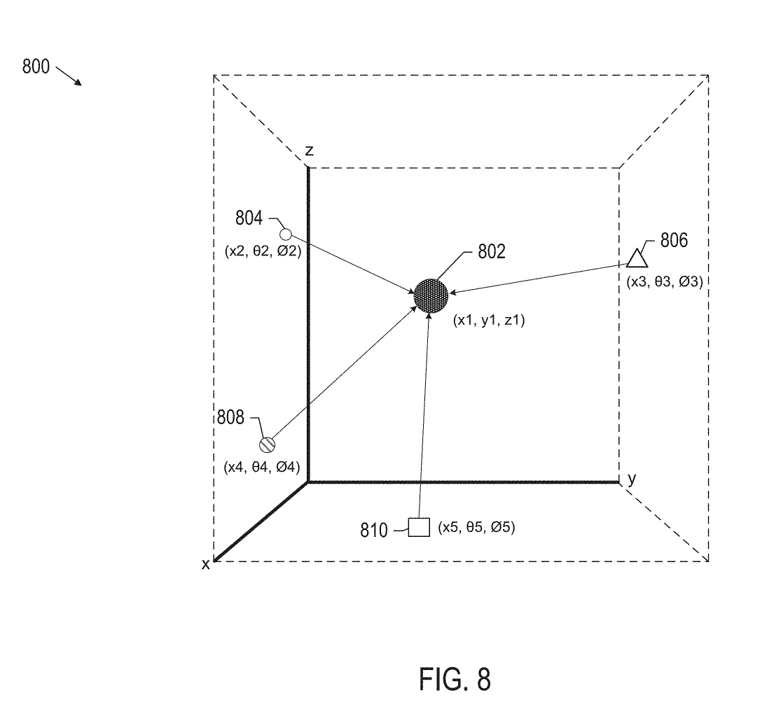

FIG. 6 illustrates an example process 600 for graphically representing data including a number of values in a multi-dimensional space. As illustrated in FIG. 6, dashed lines indicate optional operations, such that process 600 may be performed as described without including one or more of those operations. Process 600 may be performed by software, such as an application, program, etc., operating one or more physical devices (e.g., desktop, laptop, smartphone, tablet, etc.), and/or may interface with other resources, such as cloud computing resources, external databases, etc., as described above. Process 600 may be performed in conjunction with a graphical user interface and/or a virtual reality or augmented reality visualization of the data, as will be described below in reference to FIGS. 8-12.

Process 600 may begin at operation 602, where the application, program, etc., may receive one or more selections of data points or objects for modeling. Operation 602 may include receiving stock names, investment names or other identification information, sports team names, players' names, and so on.

At, at operation 604, the data corresponding to the received selections of data points or objects may be obtained, for example, via one or more databases, either local or remote to the device on which process 600 is being performed. In some aspects, process 600 may include providing selection options or other items, for defining exactly what information concerning the data point/object should be obtained.

At operation 606, the application or program may request, and receive definitions of variables to be used for evaluating the data points/objects. In some aspects, operation 606 may include receiving various information in various different forms, for example defining a risk variable, a reward variable, or other variable, as described above. In some cases, one or more of the variables may include a statistic or other value that is directly obtainable via public information, such as dividend yield, book value for share, etc., for stocks or other information. In some examples, the one or more variables may include any number of operations (e.g., in the form of equations and the like) to be performed on certain pieces of data.

At operation 608, the values of the variables selected/defined at operation 606 may be determined. This may include performing any number of calculations, as defined in operation 606. At operation 610, it may be determined if any more variables have been selected. If so, process 600 may return to operation 606 and continue to loop through operations 606, 608, and 610, until no more variables are selected. At this point, process 600 may optionally continue to operation 612, where a target for each variable may be determined or received and associated with a reference or target data point or object. The target point or object may define an ideal or target combination of variable values in which a user wants to compare other data points or objects to. This may include, for example, an ideal investment profile, select statistics of an ideal sports player, team, etc. In some aspects, the target may include one or more benchmarks, as described above in more detail.

At operation 614, the distance between the selected data appoints or objects, and in some cases, the distance between the target point or object, may be determined. The distance determination may include a geometric or Euclidean distance.

At operation 616, the data points/objects, and in some cases, the target point or object, may be translated into 3D space. Example 3D spaces are described below in greater detail, in reference to FIGS. 8-12.

In some aspects, process 600 may be utilized to display current information, without the addition or comparison to a target set of values or target data point/object (e.g., omitting operation 612). This may be particularly useful for representing a landscape of information, such as investments/stocks, sports statistics, and so on.

A specific example of a software code or an algorithm for mapping stock variables to a list of distances, which can then be used to a map the data to 3D space, is provided below:

```
multipleFinancialData[sym_, listOfProperties_ ] :=
  Join[(sym), FinancialData[sym, #] & /@ listOfProperties];
areAnyMissingQ[ list_ ] :=
  If [Length [Cases[ list, x_/; MissingQ[x] ] ] > 0, True, False];
normalizeList[ list_ ] := (list − Mean[list]) / StandardDeviation[list];
stockSymbols = WolframAlpha[“Dow Jones members”,
    {{“Result”, 1}, “ComputableData”, Podstates → {“Result_More”}];
members = WolframAlpha[“company ” <>#, “WolframResult”, TimeConstraint → 60] &/@
    stockSymbols;
mem = EntityValue[#, “Symbol”] &/@ Cases [members, Except [_Missing]];
testdata0 =
  multipleFinacialData[#1, {“Price”, “BookValuePerShare”, “EarningsPerShare”,
      “ShortRatio”, “ForwardEarnings”, “QuarterForwardEarrrings”,
      “DividendYield”, “Volatility20Day”, “FractionalChange50Day”}] &/@mem;
(*Note that the first column in testdata is the symbol*)
testdata = Cases [test.data0, x_/; : areAnyMissingQ[x]]);
header = {{“Symbol”, “BookToPrice”, “EarningsToPrice”, “ShortRatio”,
    “ForwardEarningsToPrice”, “QuarterForwardEarningsToPrice”,
    “DividendYield”, “Volatility20Day”, “FractionalChange50Day”}};
(*Assemble Value Stock Data*)
testdata2 =
  {testdata [[All, 3]] / testdata [[All, 2]] testdata [[All, 4]] / testdata [[All, 2]],
    testdata [[All, 5]], testdata [[All, 6]] / testdata [[All, 2]],
    testdata [[All, 7]] / testdata [[All, 2]], testdata [[All, 8]]};
testdata3 = Map[normalizeList, testdata2];
benchdata3 = {Max[testdata2[[1]]], Max[testdata2[[2]]], Min[testdata3[[3]]],
    Max [testdata2[[4]]], Max[testdata2[[5]]], Max[testdata2[[6]]};
  (*Assemble Risky Stocks Data)
  (*Using Min[ ] in benchdata means the
    riskiest stocks have the highest distance values*)
  testdata4 = {testdata [(All, 5]], testdata[[All, 9]], testdata[[All, 10]]};
  benchdata4 =
      {Min[testdata[[All, 5]]], Min[testdata[ [All, 9]]], Min[testdata [[All, 10]]]};
  distFromBench[ benchdat_, testdat_ ] :=
    Module[{devbench3, distbench3sq, distbench3, distances0, distances},
      devbench3 = Map[benchdat − #&, Transpose [testdat]];
      distbench3sq = Map[ #\hat{ }2& devbench3, {2}];
      distbench3 = Map[ (Apply[Plus, #]) \hat{ } (1 / 2) &, distbench3sq ];
      distances0 = Transpose[Join[{testdata[[All, 1]]}, {distbench3}]];
      distances = Sort[distances0, #2[ [2] ] > #1 [ [2] ] &];
      Return[distances] ;
    ];
  valueStocks = distFromBench [ benchdata3, testdata3 ];
  riskyStocks = distFromBench [ benchdata4, testdata4 ];
  riskyStocks
  {{NYSE:GS, 0.12148}, {NYSE:JPM, 0.403459}, {NYSE:DD, 0.455702},
{NASDAQ:AAPL, 0.636283}, {NASDAQ: MSFT, 0.682117}, {NYSE:VZ, 0.787088},
{NYSE:DIS, 0.820887}, {NYSE:NKE, 1.01138}; {NASDAQ:CSCO, 1.04392},
{NYSE:GE, 1.10033}, {NYSE:PFE, 1.10589}, {NYSE:JNJ, 1.14212}, {NYSE:MCD, 1.26595},
{NYSE:XOM, 1.40164}, {NYSE:UTX, 1.41244}, {NYSE:HD, 1.60277}, {NYSE:KO, 1.63053},
{NYSE:UNH, 2.08112}, {NYSE:BA, 2.14153}, {NYSE:CVX, 2.55133}, {NYSE:V, 2.78094},
{NASDAQ:INTC, 2.90289}, {NYSE:TRV, 3.00248}, {NYSE:PG, 3.24057},
{NYSE: AXP, 3.35114}, {NYSE:CAT, 3.63133}, {NYSE:IBM, 3.99038},
{NYSE:WMT, 4.59021}}
valueStocks
{{NYSE:UTX, 1.43643}, {NYSE:DIS, 1.47293}, {NYSE:JNJ, 1.57288},
  {NASDAQ:CSCO, 1.59676}, {NYSE:JPM, 1.86101}, {NYSE:PFE, 1.90903},
  {NASDAQ:MSFT, 2.05909}, {NYSE:NKE, 2.12723}, {NYSE:GE, 2,16135},
  {NYSE:XOM, 2.22498}, {NASDAQ:AAPL, 2.32894}, {NYSE:UNH, 2.34948},
  {NYSE:HD, 2.69554, {NYSE:MCD, 2.821}, {NASDAQ:INTC, 2.92357},
  {NYSE:GS, 2.92436},
  {NYSE:KO, 3.06058}, {NYSE:AXP, 3.07284}, {NYSE:PG, 3.09618}, {NYSE:VZ, 3.13575},
  {NYSE:BA, 3.14188}, {NYSE:CVX, 3.28311}, {NYSE:TRV, 3.45459},
  {NYSE:DD, 3.76645},
  {NYSE:WMT, 3.82656}, {NYSE:V, 3.9478}, {NYSE:CAT, 4.17869}, {NYSE:IBM, 5.56528)
```

In some aspects, once a data object is selected, it may be stored in one or more tables for specific use with the described system and process for translating information corresponding to a data object to 3D space. The specific type of data stored for each data object depends on user selection and preference, as described above. Each data object would be associated with any number of attributes, such as for investments, any of: market cap, historical prices and trading volumes, price/earnings ratios, revenue, gross margin, exchange on which traded, corporate address. In other examples, an object may represent a bond, such that coupon, interest rate, yield to maturity, and so on may be stored for each object. In other examples, an object may represent a currency, such that central bank interest rate, inflation rate, daily trading volume, etc., may be stored for each object. In other examples, an object may represent a commodity, such that then storage costs, yield, backwardation/contango, etc., may be stored for each object. It should be appreciated that a data object may represent a vast variety of information, defined by any number of different characteristics.

The data structure for storage, in some aspects, may be optimized for more efficient and quicker distance calculation s between data objects. The data may be stored or represented as a tree type structures such as kd-trees and vp-trees, such as described in “Data Structures and Algorithms for Nearest Neighbor Search in General Metric Spaced”, by Peter N. Yianilos, NEC Research Institute, 4 Independence Way, Princeton, New jersey 08540, the contents of which are incorporated by reference in their entirety. In other cases, the data may be stored in other ways. In some aspects, more than one table may be utilized to store information for a data object, such as through referential tables and the like. It should be appreciated that the way in which the data is stored is only a feature of, and not a defining aspect of the systems and techniques described herein. As such, the described system and methods may be implemented using any of a variety of data storage techniques not described herein.

In any data storage implementation, the data is accessible such that it may be retrieved and or modified via interaction's with 3D/VR space, as will be described in greater detail below.

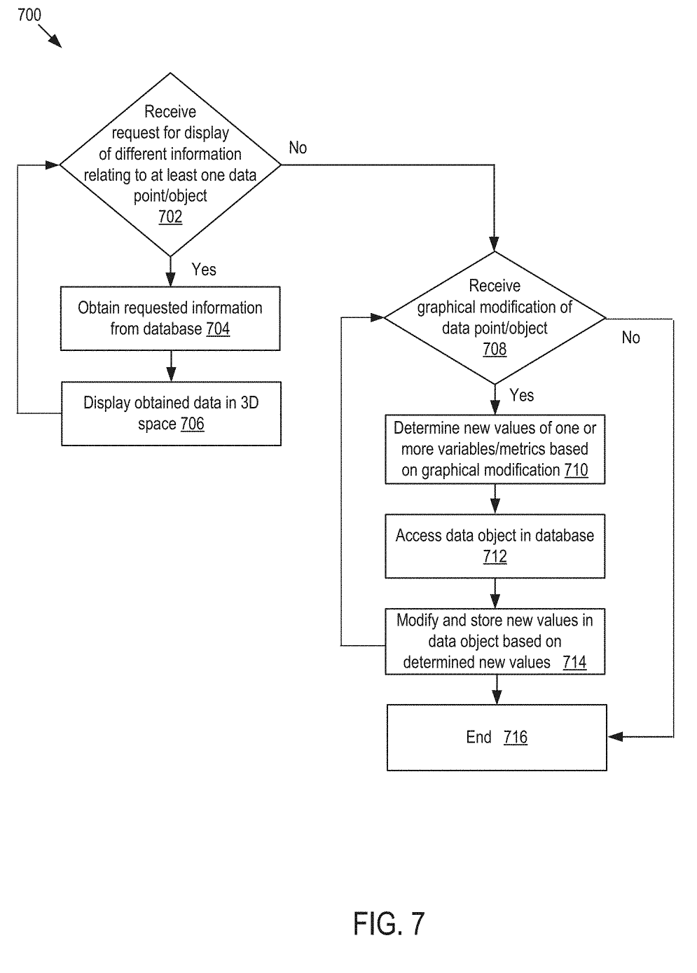

FIG. 7 illustrates an example process 700 for modifying data through graphical modifications in a multi-dimensional space. Process 700 may be performed by software, such as an application, program, etc., operating one or more physical devices (e.g., desktop, laptop, smartphone, tablet, etc.), and/or may interface with other resources, such as cloud computing resources, external databases, etc. Process 700 may be performed in conjunction with a graphical user interface and/or a virtual reality or augmented reality visualization of the data, as will be described below in reference to FIGS. 8-12. Process 700 may also, preferably, be implemented in conjunction with process 600 described above.

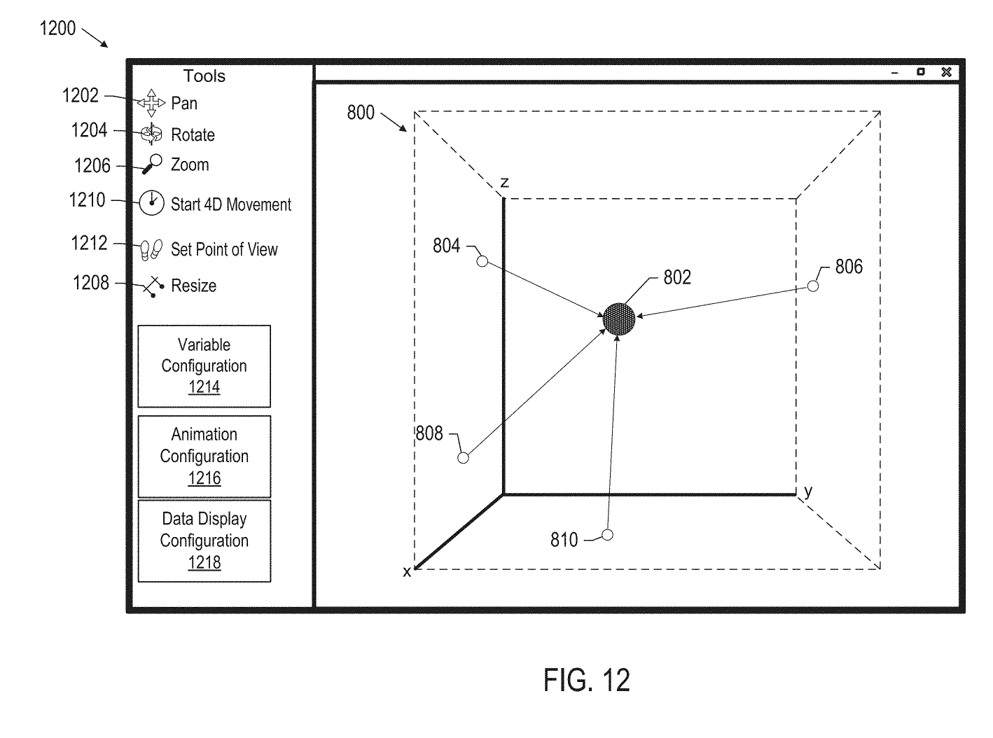

Process 700 may begin at operation 702, where it may be determined if a request for displaying different information relating to at least one data point/object is received, for example through a UI, as described below in reference to FIG. 12. This may include receiving a touch or selection of an object, zooming, etc. If a request is received, then the new information requested may be retrieved from a database or other storage location (or via an automatic internet search, etc.) at operation 706, and displayed in the 3D space at operation 706. In some cases, the database may be local or remote from the device on which process 700 is being performed. Process may continue to cycle through operations 702, 704, and 706, until no more requests for displaying different information are received.

At this point, process 700 may continue to operations 708, in which it may be determined if a graphical modification of a data point object has been received. This may include moving a data object in the 3D space and other operations, as described below in reference to FIG. 12. If a request is received, a new value or values may be determined for one or more metrics/variables based on the graphical modification, at operation 710. For example, if a data object is moved a certain distance along the x axis and the y axis of the 3D space, then based on the new position, the new variable information would be determined (the 3D space accurately represents via distances the different values for each axis). At operation 712, the data object may be accessed, for example, via one or more databases as described above, and the new variable information associated with and stored as the object entry in the database, at operation 714. Process 700 may continue to loop through operation 708 through 714, until no more modifications are received, at which point process 700 may end.

In some aspects, the financial, sports, or other information, and the analysis thereof may be graphically displayed or represented as a three or more dimensional model, such as model 800 illustrated in FIG. 8. The model 800 may be generated via process 600 described above in reference to FIG. 6, and/or may be modified via process 700 described above in reference to FIG. 7.

As illustrated, an ideal or target set of variables may be determined and defined as a reference point, and mapped to a three dimensional grid or space 800 as point or sphere 802. The target set of variables may define a point or object in the 3D space (can be a three dimensional object, such as a sphere, cube, rectangular prism, pyramid, etc.) Potential stock or other investment options, defined by any number of user variables, may similarly be mapped to the 3D space 800, in relative location to the ideal point or target 802, as points/objects 804, 806, 808, 810, etc. As illustrated, each of the x, y, and z axis of the space 800 may define a certain variable, such as one or more of Risk, Reward, a variety of financial or investment statistics, sports team or player statistics, etc., as described above. In some cases, one or more axis may represent a combined variable. The combination of variables may be configurable, and may include addition, averaging, normalization then averaging, weighted addition, weighted addition after normalization, and so on. In some aspects combining one or more variables or metrics may include using principal component decomposition techniques, and/or selecting top variables or metrics for the 3 axes. In some cases, selection options may be automatically generated based on industry standards or common practices, and the choice of which variables to indicate on which axes may be left to user determination. It should be appreciated that in some cases, the actual variables configured for the visualization are under the control of the user, to provide a better way to visual data and data relationships and analytics.

In one example, various different types of information may be displayed within 3D space 800, such as representations of values, coordinates of various points, vector relationships, and so on, by virtue of special relationships in the 3D space. In one example, 3D coordinates (e.g., x, y, z) or vector information (e.g., distance, angle, 1, angle 2, defining a vector from the data point to the target point) may be displayed next to each data point/object. In some aspects, other visual indicators may be used to represent additional variables, such that may be user defined. These may include representing, for example, a risk or reward variable, or other variable via a texture or characteristic of a point or sphere, such as fill pattern, line weight, line texture such as dashing, shape, color, size, and so on. The different variables may be defined, and selected and visually configured by a user, via a user interface as described in more detail below, to customize the space to communicate the most pertinent information to a specific user.

In this way, the relative difference between different investment options, and the relative difference between investment options and an ideal may be more readily conveyed via a much more effective and efficient way—via the representation of distance in the 3D space 800. Per the other visual indications above, categorical variables (e.g., defined in ranges, binary, etc.) may alternatively or in addition be visually represented via texture, color, shape, dimensions or size, flashing or blinking or other movement type indicators, and so on, to convey a large amount of information that may be practically immediately comprehended by a user. In this way, much more information may be represented and communicated to a user graphically, while minimizing the amount of time and space required to communicate and represent such information.

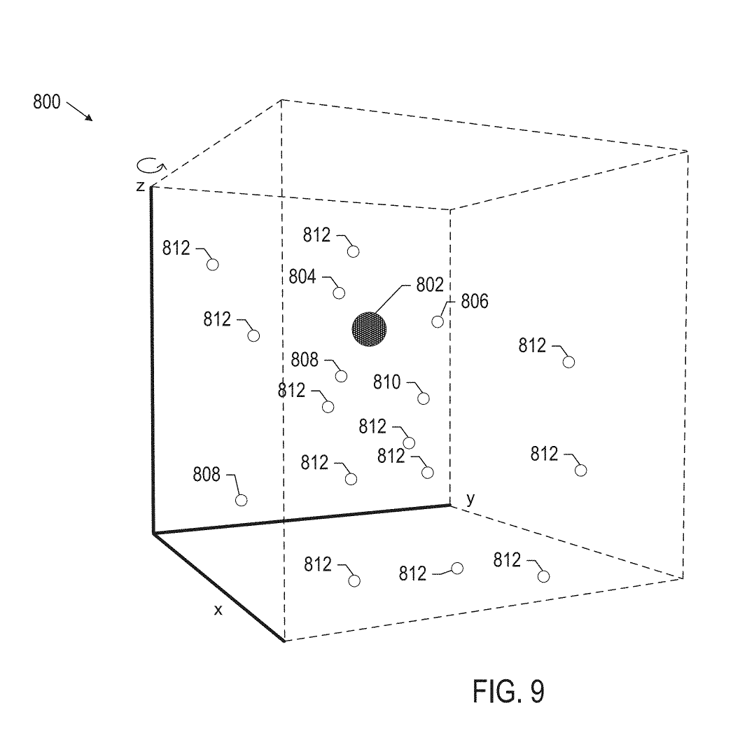

In some aspects, various tools, buttons, selections, options, controls, etc., may enable manipulation of the 3d space 800, such as by rotation about one or more axis, as illustrated in FIG. 9. It should be appreciated that the 3D space modeled in FIGS. 8 and 9 can be adapted for display in a traditional computer screen environment, or in a virtual or augmented reality environment. As illustrated in FIG. 9, a large number of data objects 812 are illustrated. It should be appreciated that any number of data points or objects may be displayed within 3D space 800.

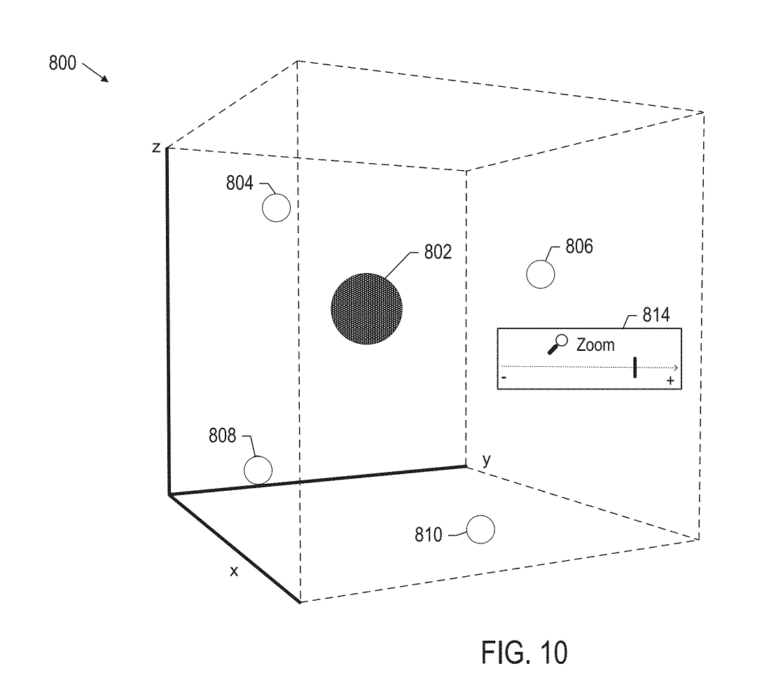

As illustrated in FIG. 10, a zooming control or controls 814 may be implemented to modify perspective of the 3D space 800. In some aspects, zooming into a region or focal point in the 3D space 800 may provide more detail of data points or objects in the field of view (and zooming out, less detail). In some aspects, zooming may simply display more or less data points or objects in the field of view. As illustrated, FIG. 10 represents the data objects of FIG. 9, but zoomed in to a higher degree, such that only a few data points are displayed and the size of the data objects is larger. However, it should be appreciated that the data objects may stay the same size for a zoom adjustment. These and other various configuration parameters may be adjusted by a user through a user interface, as described in more detail below. In some cases, these controls may be implemented via standard zooming controls (such as a bar or other selectable item 814 via a pointer or mouse). In other cases, zooming controls may be linked to gestures in VR spaces, such as moving hands or arms away to zoom (e.g., breaststroke type movement), and moving hands or arms together (reverse breastroke) to zoom out.

In some aspects, zooming controls may additionally or alternatively include changing the point in the 3D space from which the 3D space is viewed (changing in essence the user location within the 3D space). This may be accomplished via a display screen, or via 3D movement in a virtual reality or augmented reality space. In this scenario, selection of the next perspective location may be selected by touching the screen or double tapping on a location in the virtual reality space. In some implementations, virtual reality of the 3D space may include visualization within the space the size of a room, for example, to provide a immersive experience. This type of visualization would enable a user to walk around the various data objects, manipulate objects, access more information of objects by touching them, changing scale, size, color, density, weight, brightness, contrast, spacing, size, shape, etc. In some aspects, a target object may be moved in the space, and its values re-calculated, and displayed, for example, to enable real-time or near-real time evaluation of assumption changes, such as for investment evaluation purposes.

In some examples, 3D or virtual reality controls may include projecting “touch pads” or other control objects on the walls/ceilings/floor or even in the volume of a room that allow a user to manipulate the data and the perspective of the 3D space. In one example, these controls may include virtual “keyboards,” or other similar controls use a projection to detect user movements (e.g., projecting a laser image of a keyboard onto a tabletop or directly in the volume of the room).

It should be appreciated that these gesture controls are only given by way of example. Various other gestures for zoom and other controls are contemplated herein.

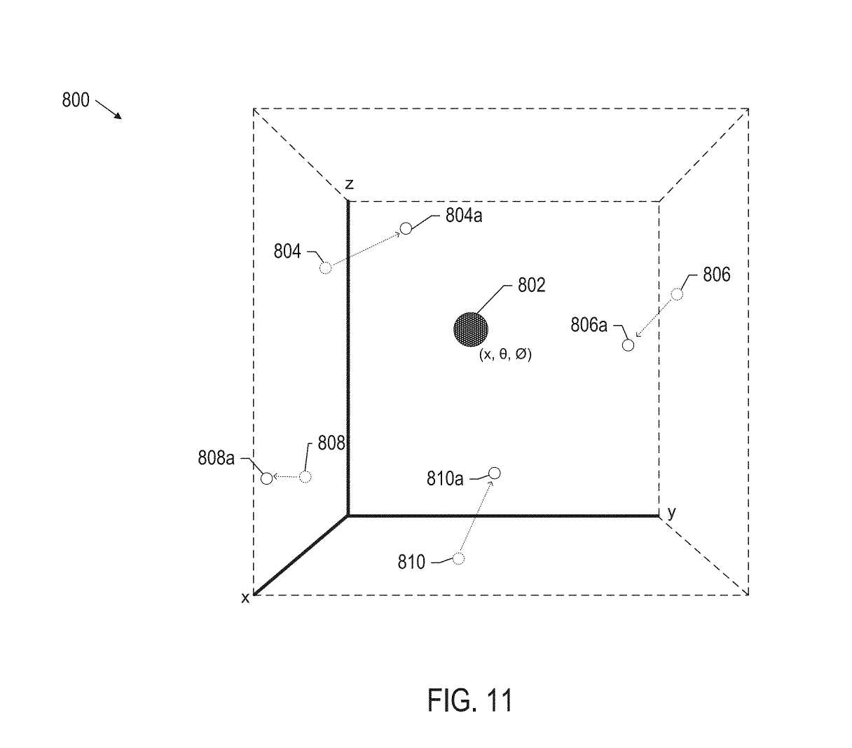

As illustrated in FIG. 11, another variable, metric, or dimension, such as change of one or more variables, may be represented by movement in the 3D space. For example data points/objects 802, 804, 806, 808, and 810 may move over time, through an animation, to new locations 802a, 804a, 806a, 808a, and 810a within 3D space 800. This feature, to an even greater extent, offers the ability to represent large amounts of data (e.g., 3 or more variables at multiple points in time) in an extremely efficient way. With this feature, trends in the data visualized can be illustrated in matters of seconds in one screen space, whereas to display that amount of data in a table or chart, or to read and comprehend that amount of data alone, let alone to derive trend information, would take multiples of that amount of time. In yet some aspects, change of movement over time may also be represented (e.g., acceleration) to yet enable the more efficient display, and corresponding more efficient communication of data, or trends of trend data.

In some examples, time, or a fourth dimensions in the 3D space, can be configured via a user interface, to change the time period illustrated by animation in the 3D space, change the rate at which time is modeled via animation (how quickly a certain time period is modeled or length of the animation), and so on. In some cases, different changes in the data, for example, corresponding to one or more data objects, may be represented differently. In addition to or alternative to movement in the 3D space, an object could change shape or color through an animation to indicate degrees of change in one or more variables. The types of changes indicated, the way in which they are indicated, thresholds for different visual changes, etc., may all be configured by the user through user interface controls. For example, a first data object may represent a stock investment. The stock may initially be red and represented by a small sphere, representing a small cap stock losing money. Upon starting an animation over a given time period, the same data object may transform to being green and a much bigger triangular prism, to represent a large cap stock that is making money but has changed sector. UI controls may enable almost endless configuration of changes of different variables represented in a variety of visual ways, such as changes in color, shape, texture, size, and so on.

FIG. 12 illustrates an example graphical user interface (GUI) 1200 that may be used to manipulate and configure the 3D space 800 illustrated and described in reference to FIGS. 8-11 above. These controls may include panning 1202, rotating, 1204, zooming 1206, and/or re-sizing 1208 of the perspective view of 3D space 800. These controls may also include an item 1210 to start a simulation of variables taken over a configured time period. In some aspects, the point of view may be set via control 1212, for example, via selecting a point in or around the 3D space. In this way, for example, the relative change of certain variables over time may be highlighted or discounted (e.g., changing the perspective to align with one axis).

In some aspects, the controls may enable configuration of different variables, via item 1214, shown in the 3D space and precisely how they are shown. This may include configuring certain colors, shapes, sizes, etc., to represent different values or different variables. The GUI 1200 may also include selection options for configuring animation 1216, including time period, length of animation and so on.

The GUI 1200 may also include controls or selection options 1218 for configuring what data is displayed and exactly how it is displayed (via visual indicators, via expanding a data object, etc.).

GUI 1200 is configured to be used primarily with a display device, such as a screen (e.g., as part of a desktop, laptop, smart phone, tablet, etc.). However, it may be adapted for use in virtual or augmented reality by using similar controls accessed via certain gestures. In some cases, one or more additional sensors may be used to project one or more selection options onto a surface. In some cases other devices and/or sensors may be used to detect relative motion, such as the Vive motion controllers from HTC, the Oculus Touch as part of the Oculus Riff VR system, or Mixed Reality Controllers by Microsoft. In some examples, 3D or virtual reality controls may include projecting “touch pads” or other control objects on the walls/ceilings/floor or even in the volume of a room that allow a user to manipulate the data and the perspective of the 3D space. It should be appreciated that any of a variety of display and virtual or augmented reality systems, devices, hardware, interface software, etc., may be used with the described systems and techniques to enhance the user experience and to better represent data analytics and relationship between data, as described herein.

Any processes, descriptions or blocks in flowcharts described herein should be understood as representing modules, segments, or portions of code which include one or more executable instructions for implementing specific logical functions or steps in the process, and alternate implementations are included within the scope of the exemplary embodiment of the present advancements in which functions may be executed out of order from that shown or discussed, including substantially concurrently or in reverse order depending upon the functionality involved.

Obviously, numerous modifications and variations of the present advancements are possible in light of the above teachings. In particular, while the application of the present advancement has been described with respect to events such as conventions, sports and concerts, other applications are within the scope of the appended claims. For example, without limitation, the present advancement may be applied to video games, TV, cell phones, tablets, web applications, and any other platform as would be understood by one of ordinary skill in the art. It is therefore to be understood that within the scope of the appended claims, the present advancements may be practiced otherwise than as specifically described herein.

1. A non-transitory computer readable storage medium having stored thereon instructions that, upon execution by at least one processor, cause the at least one processor to perform operations for generating a three-dimensional (3D) model, the operations comprising:
obtaining data corresponding to multiple data objects for modeling;
determining at least three variables for evaluating the multiple data objects;
determining a target value for each of the at least three variables;
determining a distance between each of the multiple data objects; and
translating and displaying the multiple data objects into three dimensional space as the three-dimensional model at least in part based on the determined distance, wherein the distance between each of the multiple data objects accurately represent difference in values of the at least three variables.

2. The non-transitory computer readable storage medium of claim 1, wherein the instructions further cause the at least one professor to perform the additional operations of:
generating a graphical user interface, wherein the graphical user interface comprises selection items for at least one of configuring or manipulating the three dimensional model.

3. The non-transitory computer readable storage medium of claim 1, wherein the instructions further cause the at least one professor to perform the additional operations of:
determining a target value for each of the at least three variables;
determining a distance between each of the multiple data objects and the at least three target values for each of the multiple data objects;
translating and displaying the at least three target values into three dimensional space as part of the three-dimensional model, wherein the distance between each of the multiple data objects and the at least three target values accurately represent difference in values of the at least three variables.

4. The non-transitory computer readable storage medium of claim 1, wherein obtaining the data corresponding to multiple data objects for modeling comprises obtaining data corresponding to multiple points in time of an object to be modeled; and wherein the instructions further cause the at least one professor to perform the additional operations of:
animating movement of at least one of the multiple data objects based on the obtained data corresponding to multiple points in time, wherein the movement represents a change in at least one value over a time period captured by the multiple points in time.

5. The non-transitory computer readable storage medium of claim 1, wherein displaying the multiple data objects and the at least three target values into three dimensional space comprises displaying in a virtual reality or augmented reality space.

6. The non-transitory computer readable storage medium of claim 1, wherein the instructions further cause the at least one processor to perform the additional operations of:
generating a graphical user interface, wherein the graphical user interface comprises selection items for configuring additional information of the multiple data objects and how the additional information is displayed.

7. The non-transitory computer readable storage medium of claim 6, wherein the selection items further comprise items for configuring different graphical representations of the addition information.

8. The non-transitory computer readable storage medium of claim 7, wherein the different graphical representations of the addition information comprise at least one of color, shape, texture, size, fill pattern, movement, or brightness.

9. The non-transitory computer readable storage medium of claim 1, wherein at least one of the at least three variables for evaluating the multiple data objects comprises a combination of two or more variables.

10. The non-transitory computer readable storage medium of claim 1, wherein each of the multiple data objects represents investments.

11. The non-transitory computer readable storage medium of claim 1, wherein each of the multiple data objects represents at least one of a sports team or a sports player.

12. The non-transitory computer readable storage medium of claim 1, wherein determining the distance between each of the multiple data objects is based on a user selectable metric.

13. An information processing apparatus for analyzing a distribution of possible future sports outcomes, comprising:
a processor programmed to receive a possible future sports outcome distribution request identifying sports outcome distribution information a user wishes to obtain relating to a possible future sports outcome distribution, and one or more different types of sports performance variables relating to at least one of the possible future sports outcomes and a benchmark,
generate at least two vectors containing the one or more sports performance variables based on the possible future sports outcome distribution request,
calculate a similarity value by calculating a distance between the at least two vectors,
and analyze the similarity value and the possible future sports outcome request, and
determine output information, as a distribution of possible future sports outcome advice for a user, correlating to the possible future sports outcome distribution request and the similarity values based on results of the analysis,
wherein each vector is one of the following types:
a sports performance reward vector containing one or more sports performance variables which the user believes relate to an expected possible future outcome distribution of the sports performance variables,
a sports performance risk vector containing one or more sports performance variables which the user believes relate to a level of risk of the sports performance outcome distribution,
a benchmark reward vector containing the one or more sports performance variables which the user believes relate to the expected possible future outcome distribution of the sports performance, the one or more variables having values identified by the benchmark, or
a benchmark risk vector containing the one or more sports performance variables which the user believes relate to the level of risk of the expected possible future outcome distribution of the sports performance, the one or more variables having values identified by the benchmark.

14. An information processing apparatus for analyzing possible future sports outcomes, comprising:
a processor programmed to receive a possible future sports outcome request identifying sports outcome information a user wishes to obtain relating to a possible future sports outcome, and one or more different types of sports performance variables relating to at least one of the possible future sports outcomes and a benchmark,
generate at least two vectors containing the one or more sports performance variables based on the possible future sports outcome request,
calculate a similarity value by calculating a distance between the at least two vectors,
and analyze the similarity value and the possible future sports outcome request, and
determine output information, as possible future sports outcome advice for a user, correlating to the possible future sports outcome request and the similarity value based on results of the analysis,
wherein each vector is one of the following types:
a sports performance reward vector containing one or more sports performance variables which the user believes relate to an expected possible future outcome of the sports performance variables,
a sports performance risk vector containing one or more sports performance variables which the user believes relate to a level of risk of the sports performance,
a benchmark reward vector containing the one or more sports performance variables which the user believes relate to the expected possible future outcome of the sports performance, the one or more variables having values identified by the benchmark, or
a benchmark risk vector containing the one or more sports performance variables which the user believes relate to the level of risk of the expected possible future outcome of the sports performance, the one or more variables having values identified by the benchmark.
